(19) United States
(12) Patent Application Publication
(10) Pub. No.: US 2023/0096350 A1
(43) Pub. Date: Mar. 30, 2023

(54) DISPLAY DEVICE

(71) Applicant: BenQ Materials Corporation, Taoyuan (TW)

(72) Inventors: Yi-Jhen Lin, Taoyuan (TW); Ting-Wen Cheng, Taoyuan (TW); Jian Hung Wu, Taoyuan (TW)

(73) Assignee: BenQ Materials Corporation, Taoyuan (TW)

(21) Appl. No.: 17/548,365

(22) Filed: Dec. 10, 2021

(30) Foreign Application Priority Data
Sep. 27, 2021 (TW) 110135788

(51) Int. Cl. G02F 1/1335; G02F 1/137

(52) U.S. Cl. CPC G02F 1/133504; G02F 1/133528; G02F 1/137

(57) ABSTRACT

The present invention relates to a display device, which includes a backlight module, an active dimming layer, a liquid crystal display panel, and a moire elimination layer. The active dimming layer is arranged on the light emitting surface of the backlight module, and includes a plurality of dimming sub-regions that can change the light polarization directions. The liquid crystal display panel is arranged on the light exiting surface of the active dimming layer. The moire elimination layer is arranged on the outer surface of the liquid crystal display panel. The display device can improve the optical interference phenomenon through the moire elimination layer, and has a better contrast gain effect.

### CROSS-REFERENCE TO RELATED APPLICATION

This application claims the priority benefit of Taiwanese Application Serial Number 110135788, filed Sep. 27, 2021 which is incorporated herein by reference.

### TECHNICAL FIELD

The present invention relates to a display device and in particular, relates to a display device with an increased contrast and eliminated light interference such as moire effect.

### BACKGROUND OF THE INVENTION

As consumers have more requirements for the image quality of displays, displays with different light-emitting mechanisms have appeared on the market, such as liquid crystal displays (LCDs), organic light-emitted diode displays (OLEDs) and micro light-emitted diode displays (Micro-LED Displays). The liquid crystal display is not a self-luminous display, the contrast and the pure black dark state is less comparable to the self-luminous OLED and Micro-LED displays. However, because the consumers' demand on the increased display area is growing, the current liquid crystal display on the large display is still competitive with the other display with the same size in view of the manufacture and cost of LC display.

Therefore, it is only necessary to try to reduce the light leakage of the dark state image and through the local-dimming technology, so that the liquid crystal display can achieve the high contrast effect as the self-luminous electroluminescent diode display. It is known that the local-dimming effect can be formed by the point light source arrangement design and driving technology of the backlight module. However, because the number of point light sources in the backlight module is usually far less than the number of pixels of the display, only a larger area dimming effect can be obtained. It is difficult to obtain independent dimming effects of the pixel-level as in self-luminous displays. Therefore, a method of arranging an active dimming layer on the backlight module is proposed. The active dimming layer can control the local penetration degree of the backlight source and reach the pixel-level area. In the past, micro-electromechanical light valves could be used for light control, and the current Thin-Film Transistor (TFT) technology in the field of liquid crystal display can still be used to drive liquid crystal light valves, which can achieve individual dimming effect of multiple small areas.

Referring to FIG. 1A, it shows a perspective diagram of a conventional display device 100, in which an active dimming layer 2 is disposed on a liquid crystal panel 1. The liquid crystal panel 1 comprises a liquid crystal cell 13 disposed between a first polarizer 11 and a second polarizer 12. An active dimming layer 2 comprises a dimmable liquid crystal cell 23 and a third polarizer 21 disposed between the dimmable liquid crystal cell 23 and the backlight module 3 to polarize the light of backlight module. The active dimming layer 12 is for controlling the light from the single pixel to pass through the liquid crystal panel 1 and does not provide display function and thus, no color filter element and the like is added to reduce the light transmission. Moreover, because the pixels in the liquid crystal cell 13 and the dimmable liquid crystal cell 23 of the display device 100 are periodically aligned, and the size, number, and the repeat period of the pixels are set similarly to each other in order to obtain preferred individual dimming effect thereof. Therefore, the arrangement and the shape of each pixel is needed to be designed specifically. Alternatively, as shown in FIG. 1B, a perspective view of the display device 100′, a moire elimination layer 4 is disposed on the light exiting side of the active dimming layer 2 or on one side of the liquid crystal cell 13 to transform the periodicity and the direction of the light exiting from the active dimming layer 2 in order to reduce the moire defect between the active dimming layer 2 and the liquid crystal panel 1. However, for reaching the purpose, the un-polarized light L from the backlight module 3 passes through the active dimming layer 2 to transform as a single directional polarized light L1 and then, passes through the moire elimination layer 4 of the display device 100′, as shown in 1B, to transform the periodicity and the direction to generate a partial-depolarized polarized light L2. The light L2 again passes through the first polarizer 11 and the second polarizer 12 of the liquid crystal panel 1 to emit out the polarized light L3. The light efficiency of the light L3 is lost again to affect the result which is expected to increase the contrast ratio by using the active dimming layer 2.

Therefore, it demands a display device with an active dimming layer to increase the contrast of the liquid crystal panel, to eliminate moire generated between the active dimming layer and the liquid crystal panel, and to avoid the decreased light efficiency of the backlight module.

### SUMMARY OF THE INVENTION

The present invention is to provide a novel display device.

The present invention is to provide a display device comprising a backlight module; an active dimming layer disposed on a light emitting surface of the backlight module and comprising a plurality of dimming sub-regions for changing polarizing directions of light; a liquid crystal panel disposed on a light exiting surface of the active dimming layer and comprises a first polarizer, a second polarizer and a liquid crystal cell disposed between the first polarizer and the second polarizer, the second polarizer disposed between the liquid crystal cell and the active dimming layer; and a moire elimination layer disposed on a viewing side of the first polarizer; wherein the haze of the moire elimination layer is between 65% and 85%.

In an embodiment of the display device of the present invention, the first polarizer of the liquid crystal panel has a first absorption axis, the second polarizer has a second absorption axis, and the first absorption axis and the second absorption axis are parallel or perpendicular to each other.

In another embodiment of the display device of the present invention, the active dimming layer comprises a dimmable liquid crystal cell and a third polarizer between the dimmable liquid crystal cell and the backlight module, wherein the third polarizer has a third absorption axis parallel or perpendicular to the second absorption axis of the second polarizer.

In still another embodiment of the display device of the present invention, the moire elimination layer comprises a plurality of scattering particles dispersed in a resin matrix.

In a further embodiment of the display device of the present invention, the scattering particles are inorganic metal oxide particles and/or organic resin particles.

In still a further embodiment of the display device of the present invention, the thickness of the moire elimination layer is between 10 μm to 30 μm.

In still a further embodiment of the display device of the present invention, the first polarizer, the second polarizer and the third polarizer are independent dye type polarizers, coating type polarizers, grating type polarizers or combinations thereof.

In still a further embodiment of the display device of the present invention, the surface of the moire elimination layer further comprises a functional film disposed on the moire elimination layer, and the functional film is selected from one of a group consisting of a hard coating film, an anti-fouling film, an anti-reflection film and an ant-glare film or combinations thereof.

In still an embodiment of the display device of the present invention, the moire elimination layer is a scattering adhesive layer.

### BRIEF DESCRIPTION OF THE DRAWINGS

FIG. 1A is a perspective view of a conventional display device 100 with an active dimming layer.

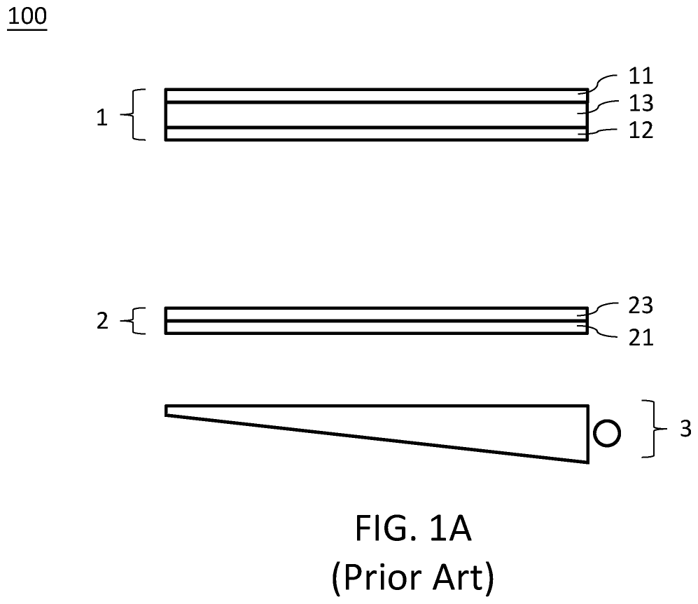

FIG. 1B is a perspective view of another conventional display device 100′ with an active dimming layer.

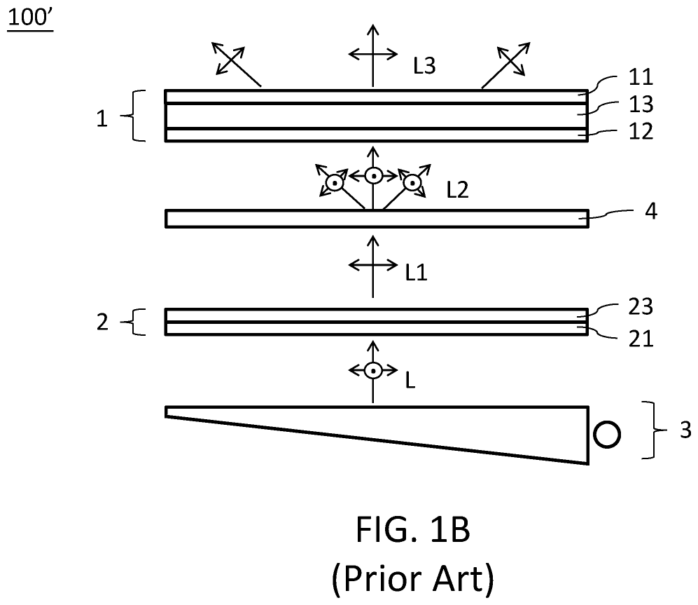

FIG. 2A is a perspective view of a display device 200 of a preferred embodiment of the present invention.

FIG. 2B is a diagram of the light path of the display device 200 of a preferred embodiment of the present invention.

FIG. 3 is a perspective view of another display device 300 of a preferred embodiment of the present invention.

### DETAILED DESCRIPTION OF THE INVENTION

With reference to the following more detailed description and claims taken in conjunction with the accompanying drawings. The purpose of the drawings is only for illustrating the present invention and may not exhibit the true proportions and precise configuration. Thus, the drawings cannot be used limit the concept and scope of the present invention. The present disclosure is only defined by the appended claims.

The following description together with the accompanying drawings is to illustrate embodiments of the wound treatment system of the present invention. For understanding, the same elements in the following embodiments are described with the same symbols.

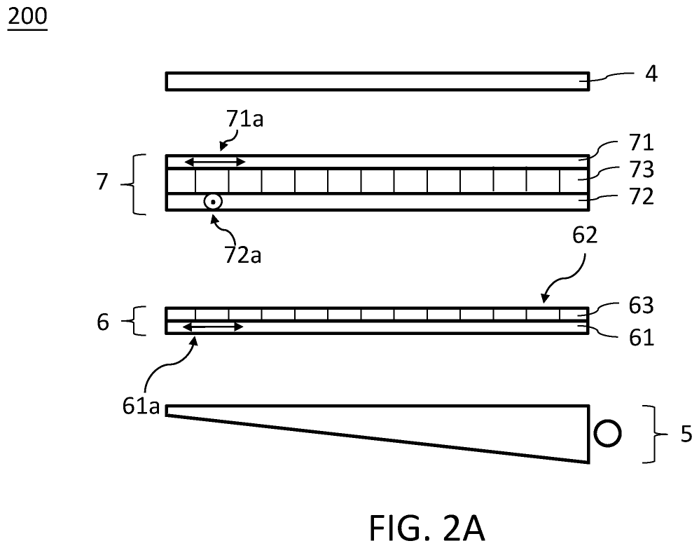

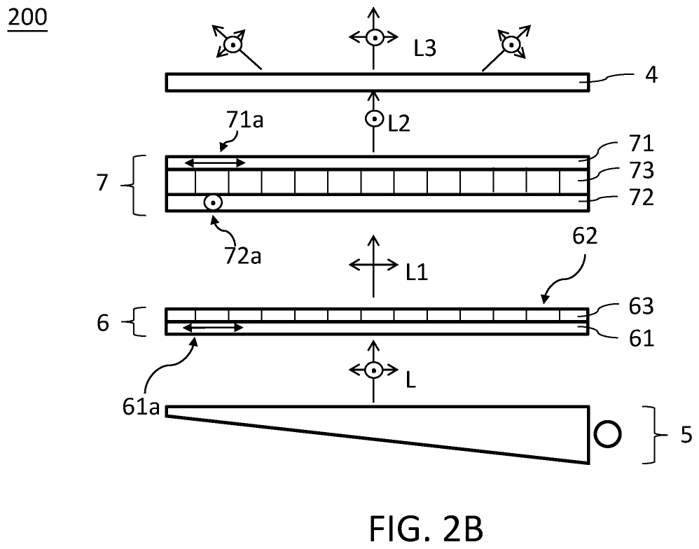

Referring to FIG. 2A, it shows a perspective diagram of the display device of a preferred embodiment of the present invention. The display device 200 comprises a backlight module 5; an active dimming layer 6 disposed on the light emitting surface of the backlight module 5 and comprising a plurality of dimming sub-regions 62 for changing polarizing directions of light; a liquid crystal panel 7 disposed on the light exiting surface of the active dimming layer 6, and the liquid crystal panel 7 comprises a first polarizer 71, a second polarizer 72 and a liquid crystal cell 73 disposed between the first polarizer 71 and the second polarizer 72, wherein the second polarizer 72 disposed between the liquid crystal cell 73 and the active dimming layer 6; and a moire elimination layer 4 disposed on a viewing side of the first polarizer 71; wherein the haze of the moire elimination layer 4 is between 65% to 85%.

In an embodiment of the display device of the present invention, because a liquid crystal display changes the rotation direction of the incident light to control the normally dark mode or the normally bright mode thereof in dependent to the alignment direction of the liquid crystal in the liquid crystal cell by the type the liquid crystal used or the application thereof when the power is off, the first absorption axis 71a of the first polarizer 71 of the liquid crystal panel 7 is parallel or perpendicular to the second absorption axis 72a of the second polarizer 72.

In another embodiment of the display device of the present invention, the active dimming layer 6 comprises a dimmable liquid crystal cell 63 and a third polarizer 61 between the dimmable liquid crystal cell 63 and the backlight module 5. The third polarizer 61 has a third absorption axis 61a, and the third absorption axis 61a and the second absorption axis 72a of the second polarizer 72 are parallel or perpendicular to each other by controlling the light rotation direction of the dimmable liquid crystal cell 63 under power-on and power-off. Accordingly, the polarized light from the each dimming sub-region 62 can be controlled to pass through the liquid crystal panel 7.

Referring to FIG. 2B, it shows a perspective diagram of a light path of the display device 200 of a preferred embodiment of the present invention. The un-polarized light L emitted from the backlight module 5 passes through the active dimming layer 6 to transform the polarized direction of the light to perpendicular to the absorption axis 72a as a light L1 to directly go through the liquid crystal panel 7. Because the light on this path does not yet pass through the moire elimination layer 4, a polarized light L2 emitted from the liquid crystal panel 7 maintains the direction and intensity to pass the moire elimination layer 4 at the outer surface of the first polarizer 71, a light L3 exited from the moire elimination layer 4 can maintain the light efficiency even though the light L3 has been partially depolarized to change the polarizing direction. Because the light L3 will not go through another polarizer to decrease the light intensity, the light efficiency of the light L3 will not reduce, and, therefore, the moire elimination layer 4 has a small effect on the increased contrast ratio by the active dimming layer 6.

In an embodiment of the display device of the present invention, the moire elimination layer 4 is a layer comprising, for example, a plurality of scattering particles (not shown) dispersed in a resin matrix (not shown) to refract the incident light to change the periodicity and the direction. The scattering particles (not shown) can be the inorganic metal oxide particles and/or the organic resin particles with different refractive index with the resin matrix.

In an embodiment of the display device of the present invention, for providing sufficient refraction of light, the thickness of the moire elimination layer 4 is preferably more than 10 μm and less than 30 μm to prevent the image from burring resulted from excessive refraction.

In an embodiment of the display device of the present invention, the first polarizer 71, the second polarizer 72 and the third polarizer 61can be dye type polarizer, coating type polarizer, grating type polarizer or the combination thereof.

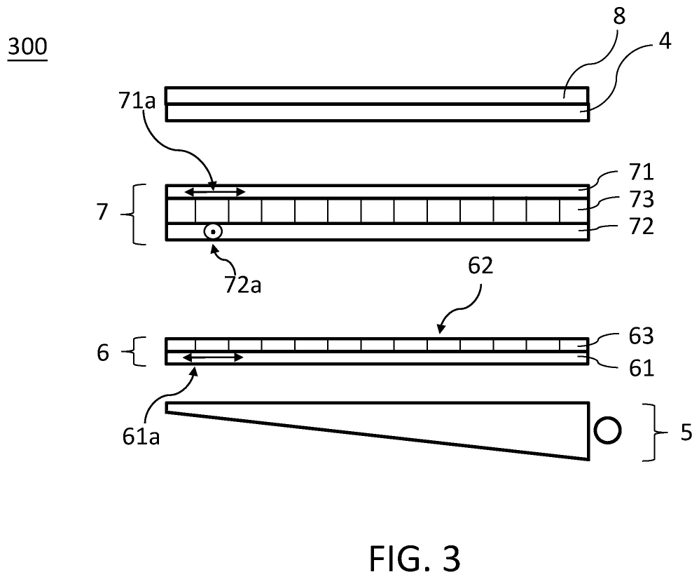

Referring to FIG. 3, it shows an exploded diagram of the display device 300. In an embodiment of a display device of the present invention, the display device 300 further comprises a functional film 8 disposed on the moire elimination layer 4. The functional film 8 can be a hard coating film, anti-fouling film, anti-reflection film, ant-glare film or combinations thereof.

In an embodiment of the display device of the present invention, the moire elimination layer can be a scattering adhesive layer. When a functional film is needed to be adhered, a scattering adhesive layer with moire elimination function can be used therefor.

The present invention will be explained in further detail with reference to the examples. However, the present invention is not limited to these examples.

### EXAMPLE

### Example 1

The display device used in Example 1 was a liquid crystal panel (Model name: 22MP58, LG) as a display panel together with an active dimming layer comprising a dimmable liquid crystal cell and a third polarizer, and a moire elimination layer. The arrangement of the display device was sequentially, from the backlight side, a backlight module, a third polarizer, a dimmable liquid crystal cell, a second polarizer, a liquid crystal panel, a first polarizer, a moire elimination layer and an anti-glare functional film. The moire elimination layer was an acrylate adhesive (brand name: 443K25H65 commercially available from Fujimori, Japan) with a thickness of 25 μm and the haze of 65%. The first absorption axis of the first polarizer of the liquid crystal panel was parallel to horizontal viewing direction of the liquid crystal panel, the second absorption axis of the second polarizer of the liquid crystal panel was parallel to vertical viewing direction thereof. The third absorption axis of the third polarizer of the active dimming layer was parallel to the horizontal viewing direction of the liquid crystal panel.

### Example 2

The display device provided in Example 2 was the same arrangement to the device provided in Example 1, except that the moire elimination layer was an acrylate adhesive (brand name: 443K25H85 commercially available from Fujimori, Japan) with a thickness of 25 μm and haze of 85%.

### COMPARATIVE EXAMPLE

### Comparative Example 1

The liquid crystal panel used in Comparative example 1 was a conventional liquid crystal display (Model name: 22MP58, LG, Korea) as a display panel without any active dimming layer. The arrangement of the display device was sequentially, from the backlight side, a backlight module, a second polarizer, a liquid crystal panel, a first polarizer and an anti-glare functional film. The first absorption axis of the first polarizer of the liquid crystal panel was parallel to horizontal viewing direction of the liquid crystal panel, the second absorption axis of the second polarizer of the liquid crystal panel was parallel to vertical viewing direction thereof.

### Comparative Example 2

The liquid crystal panel used in Comparative example 2 was a conventional liquid crystal display (Model name: 22MP58, LG, Korea) as a display panel with an active dimming layer comprising a dimmable liquid crystal cell and a third polarizer but no moire elimination layer. The arrangement of the display device was sequentially, from the backlight side, a backlight module, a third polarizer, a dimmable liquid crystal cell, a second polarizer, a liquid crystal panel, a first polarizer and an anti-glare functional film. The first absorption axis of the first polarizer of the liquid crystal panel was parallel to horizontal viewing direction of the liquid crystal panel, the second absorption axis of the second polarizer of the liquid crystal panel was parallel to vertical viewing direction thereof. The third absorption axis of the third polarizer of the active dimming layer was parallel to the horizontal viewing direction of the liquid crystal panel.

### Comparative Example 3

The liquid crystal panel used in Comparative example 3 was a conventional liquid crystal display (Model name: 22MP58, LG, Korea) as a display panel with an active dimming layer comprising a dimmable liquid crystal cell, a third polarizer and a moire elimination layer. The arrangement of the display device different from the device of Example 1 was sequentially, from the backlight side, a backlight module, a third polarizer, a dimmable liquid crystal cell, a second polarizer, a liquid crystal panel, a moire elimination layer, a first polarizer and an anti-glare functional film. The moire elimination layer was an acrylate adhesive (brand name: 443K25H65 commercially available from Fujimori, Japan) with a thickness of 25 μm and the haze of 65%. The first absorption axis of the first polarizer of the liquid crystal panel was parallel to horizontal viewing direction of the liquid crystal panel, the second absorption axis of the second polarizer of the liquid crystal panel was parallel to vertical viewing direction thereof. The third absorption axis of the third polarizer of the active dimming layer was parallel to the horizontal viewing direction of the liquid crystal panel.

### Comparative Example 4

The display device and the arrangement thereof used in Comparative example 4 was the same as that in Comparative example 3, except that the moire elimination layer was an acrylate adhesive (brand name: 443K25H85 commercially available from Fujimori, Japan) with a thickness of 25 μm and haze of 85%

As shown in Table 1, the data shown in Table 1 is the data measured by Display measuring system (Model name: DMS 903 commercially available from Autronic-Melchers, Germany) to measure the contrast ratio of the dark-state and bright-state of the displays of Examples 1 and 2 and Comparative examples 1 to 4. The data obtained from the Examples compared with that obtained from the conventional display device with single display cell of the Comparative examples by the gain ratio. Moire evaluation was conducted in the bright-state of a display device by visual observation. The evaluation criteria were to check if the moire was obvious (X), slightly and not obvious (◯), or not visible (\textcircled{∘}).

TABLE 1
The measurement results of the display device

| | Example | Example | Comparative | Comparative | Comparative | Comparative |
|---|---|---|---|---|---|---|
| | 1 | 2 | Example 1 | Example 2 | Example 3 | Example 4 |
| Haze of the moire | 65% | 85% | — | — | 65% | 85% |
| eliminating layer | | | | | | |
| Contrast | 1655 | 1249 | 115 | 2253 | 1556 | 1060 |
| Gain ratio | 14.4 | 10.9 | 1 | 19.6 | 13.5 | 9.2 |
| Moire evaluation | ◯ | ⊚ | ⊚ | X | ◯ | ⊚ |

As shown in Table 1, the contrast of the display with an active dimming layer of Comparative example 2 was enhanced as compared with the display with only a single liquid crystal cell of Comparative example 1. Although the gain ratio of the contrast of Comparative example 2 was the highest, the moire thereof was obvious to adversely affect the image quality and viewers' visual sense. The display devices with a moire elimination layer as shown in Examples 1 and 2 and Comparative examples 3 and 4 provided moire eliminating effect with different levels, the moire was un-noticeable or nearly completely eliminated. However, the moire elimination layer would destroy the conference and polarizing direction of the light to reduce the gain ratio of the contrast of the display. As shown in the Example 1 and Comparative Example 3, the Example 2 and Comparative example 4, which used the moire elimination layer with same haze, the moire elimination layer was disposed between the first polarizer and the second polarizer of the liquid crystal panel, the transmittance of the polarizing light was lost to result in a reduced contrast. In the Example 1 and Example 2 of the present invention, the moire elimination layer was disposed on the outer side of the first polarizer of the liquid crystal panel, which provided a comparable effect as that provided by the moire eliminating layer disposed between the first polarizer and the second polarizer and provided a preferable gain ratio of the contrast.

Although particular embodiments have been shown and described, it should be understood that the above discussion is not intended to limit the present invention to these embodiments. Persons skilled in the art will understand that various changes and modifications may be made without departing from the scope of the present invention as literally and equivalently covered by the following claims.

1. A display device comprising
a backlight module;
an active dimming layer disposed on a light emitting surface of the backlight module and comprising a plurality of dimming sub-regions for changing polarizing directions of light;
a liquid crystal panel disposed on a light exiting surface of the active dimming layer and comprising a first polarizer, a second polarizer and a liquid crystal cell disposed between the first polarizer and the second polarizer, wherein the second polarizer is disposed between the liquid crystal cell and the active dimming layer; and
a moire elimination layer disposed on a viewing side of the first polarizer;
wherein, the haze of the moire elimination layer is between 65% to 85%.

2. The display device as claimed in claim 1, wherein the first polarizer of the liquid crystal panel has a first absorption axis, the second polarizer has a second absorption axis, and the first absorption axis and the second absorption axis are parallel or perpendicular to each other.

3. The display device as claimed in claim 1, wherein the active dimming layer comprises a dimmable liquid crystal cell and a third polarizer between the dimmable liquid crystal cell and the backlight module, wherein the third polarizer has a third absorption axis parallel or perpendicular to the second absorption axis of the second polarizer.

4. The display device as claimed in claim 1, wherein the moire elimination layer comprises a plurality of scattering particles dispersed in a resin matrix.

5. The display device as claimed in claim 4, wherein the scattering particles are inorganic metal oxide particles and/or organic resin particles.

6. The display device as claimed in claim 1, wherein the thickness of the moire elimination layer is between 10 μm to 30 μm.

7. The display device as claimed in claim 3, wherein the first polarizer, the second polarizer and the third polarizer are independent dye type polarizers, coating type polarizers, grating type polarizers or combinations thereof.

8. The display device as claimed in claim 1, wherein the surface of the moire elimination layer further comprises a functional film disposed on the moire elimination layer, and the functional film is selected from one of a group consisting of a hard coating film, an anti-fouling film, an anti-reflection film and an ant-glare film or combinations thereof.

9. The display device as claimed in claim 1, wherein the moire elimination layer is a scattering adhesive layer.
